(19) United States
(12) Patent Application Publication
(10) Pub. No.: US 2024/0011692 A1
(43) Pub. Date: Jan. 11, 2024

(54) MACHINE FOR PRODUCING ICE CUBES

(71) Applicant: ABR INGENIEROS, S.L., FUENLABRADA (ES)

(72) Inventor: MAXIMO ROMANILLOS VAZQUEZ, MADRID (ES)

(21) Appl. No.: 18/035,375

(22) PCT Filed: Nov. 5, 2020
(86) PCT No.: PCT/ES2020/070681

§ 371 Date: May 4, 2023

(51) Int. Cl. F25C 5/10; F25C 1/045

(52) U.S. Cl. CPC F25C 5/10; F25C 1/045

(57) ABSTRACT

Disclosed is a machine for producing ice cubes, which comprises a tray specially designed for producing ice cubes, wherein an antifreeze liquid is used as a cold transmission medium, the forming tray comprising, on one side, a forming casing, and on the other side, a tray for spraying and collecting non-frozen sprayed water, the forming casing comprising a series of forming cavities aligned in rows that are each staggered with respect to the next. The machine further comprises a pair of tubes arranged at the side of the forming casing and connected to the free inside space between the forming cavities, which tubes are for pumping and returning the antifreeze liquid.

### OBJECT OF THE INVENTION

The object of the present invention, as established by the title of the invention, is a machine for producing ice cubes that uses an ice cube-forming tray and an antifreeze fluid as a refrigerating medium.

The present invention is characterized in the special constructive features of each and every one of the elements forming part of the invention, such that an ice cube-forming tray is achieved which enables an easy removal of the cubes, which requires a very low antifreeze load and enables a high production to be obtained, in addition to obtaining ice with a much higher quality.

Therefore, the present invention is within the scope of the means used in manufacturing of ice cubes.

### BACKGROUND OF THE INVENTION

Machines for producing ice cubes which consist of the formation of preferably circular pieces of ice which, once obtained, are then cut into cylindrical cube-sized portions are known in the state of the art.

Although these machines achieve the intended purpose thereof, they have technical problems related to energy efficiency and the quality of the final ice obtained.

There are also machines that directly produce ice cubes and have aspects that can be improved, such as production capacity, energy efficiency, the amount of refrigerant used, and the quality of the ice, which often appears to be cracked.

In addition, these ice-producing machines use refrigerant gases, in particular freons, which circulate inside serpentine tubes to transmit cold at two or three points of contact with the ice cube-forming cavity, whereas in our design, instead of using a refrigerant gas, we use an antifreeze liquid that covers the entire outer surface of the ice-forming cavity.

Therefore, the object of the present invention is to overcome the drawbacks of machines for producing ice cubes by developing an ice cube-forming tray such as the one described below, the essential nature of which is set out in the first claim.

### DESCRIPTION OF THE INVENTION

The object of the present invention is a machine for producing ice cubes comprising a tray specially designed for producing ice cubes, wherein an antifreeze liquid is used as a cold transmission medium.

Each forming tray comprises, on one side a forming casing, and on the other side a tray for spraying and collecting non-frozen sprayed water.

The forming casing comprises a series of forming cavities aligned in rows that are each staggered with respect to the next. The machine further comprises a pair of tubes arranged at the side of the forming casing and connected to the free inside space between the forming cavities. Said tubes are for pumping and returning the antifreeze liquid.

During the formation of the cubes the antifreeze liquid first works at a temperature below 0° C. in order to freeze the sprayed water, and when the cubes are formed, the antifreeze liquid has a temperature above 0° C. in order to make the cubes detach and come out of the forming cavities.

The spraying and collection tray comprises a base or bottom provided with a series of holes for spraying low-temperature water, this base or bottom being protected by perimeter walls surrounding the bottom or base on all sides except for one, wherein grates are arranged for collecting the sprayed and non-frozen water in the forming cavities. Under said collection grates, a collection tank is arranged which evacuates the collected water to a tank through drainage tubes.

Preferably, but in a non-limiting manner, there are three spraying holes per each forming cavity and they are centered forming an equilateral triangle centered with respect to the forming cavity. Moreover, the forming cavities have an upper hole for the inlet of air which enables the detachment of the cube, preventing it from not detaching if it did not have any inlet of air.

Thanks to the fact that there is greater contact of the antifreeze liquid on the side walls of the forming cavities, several advantages are achieved, such as the ones described below:
The production time is clearly reduced, thus the final production is much greater than with other machines.
The necessary antifreeze fluid load is very low.
The energy efficiency of the process is improved.
The quality of the ice is greater, as there are no cracks due to sudden temperature changes, since in the state of the art temperature changes can be found in the range of −30° C. to 70° C., while in our process, the ice goes from −12° C. to +3° C.

The machine in which the ice forming trays are integrated, in a possible embodiment, can comprise at least one column of forming trays, vertically aligned and in an arrangement slightly inclined towards collection means that can be static, with only the force of gravity acting, or motorized.

The forming trays can be integrated into different machines with different collection means. Thus, for example, in the embodiment shown, the trays are static and have a slight inclination, or the machine can have a series of collecting arms, or the assembly of each column of forming trays can be tilted, or the entire machine can be tilted.

Except when indicated otherwise, all of the technical and scientific elements used in this specification have the meaning commonly understood by a person with average skill in the art to which this invention belongs. When this invention is put into practice, methods and materials may be used that are similar or equivalent to the ones described in the specification.

Throughout the description and the claims, the word “comprise” and its variants are not intended to exclude other technical features, additions, components or steps. For those skilled in the art, other objects, advantages and features of the invention will be deduced from both the description and the practical use of the invention.

### DESCRIPTION OF THE FIGURES

As a complement to the description provided herein, and for the purpose of helping to make the features of the invention more readily understandable, in accordance with a preferred practical exemplary embodiment thereof, said description is accompanied by a set of drawings which, by way of illustration and not limitation, represent the following.

FIG. 1 shows a front view of the machine for producing ice cubes with the trays object of the invention.

FIG. 2 shows an isometric view of the aforementioned machine.

FIG. 3 shows an isometric bottom view of the forming casing which forms part of the tray.

FIG. 4 shows a cross section of the cube-forming casing.

FIG. 5 shows a top view of the cube-forming casing.

FIG. 6 shows a detail of the tubes for pumping and returning antifreeze liquid.

FIG. 7 shows a plan view of a water spraying and collection tray of the forming tray.

FIG. 8 shows an isometric view of the water spraying and collection tray of the forming tray.

FIG. 9 shows a detail of the pumping or collection tubes.

FIG. 10 shows a side view of the tray and collection.

FIG. 11 shows a top view of the ice cube-forming tray.

FIG. 12 shows a representation of two trays and the assembly thereof in a machine like the ones in FIGS. 1 and 2.

FIG. 13 shows a detail of the water-spraying holes.

FIG. 14 shows a schematic detail of the tray assembly.

FIG. 15 shows a top view attempting to highlight the paths of the antifreeze fluid.

### PREFERRED EMBODIMENT OF THE INVENTION

In light of the figures, a preferred embodiment of the proposed invention is described below.

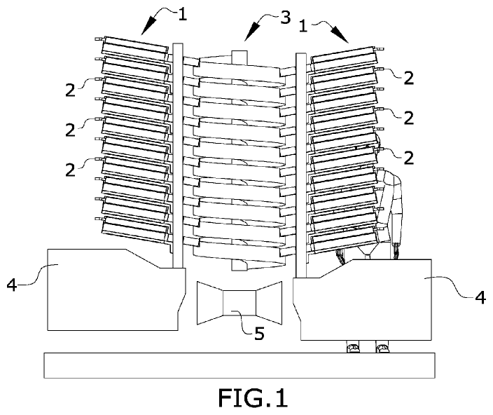

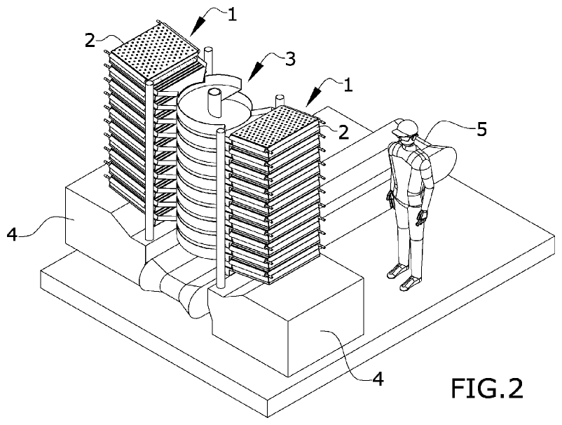

FIGS. 1 and 2 show that the machine object of the invention in which the ice cube-forming tray (2) is used comprises at least one column (1), wherein a series of forming trays (2) is arranged in a vertically aligned manner with a slight inclination, wherein the ice cubes produced are collected by spiral collection means (3) and then placed on a collecting belt (5). The machine has at least two tanks of antifreeze fluid (cold and hot) (4) to which the forming trays (2) are connected.

Each ice cube-forming tray (2) comprises a forming casing (6) under which a water spraying and collection tray (11) for the excess sprayed water, as well as the cubes produced, is arranged.

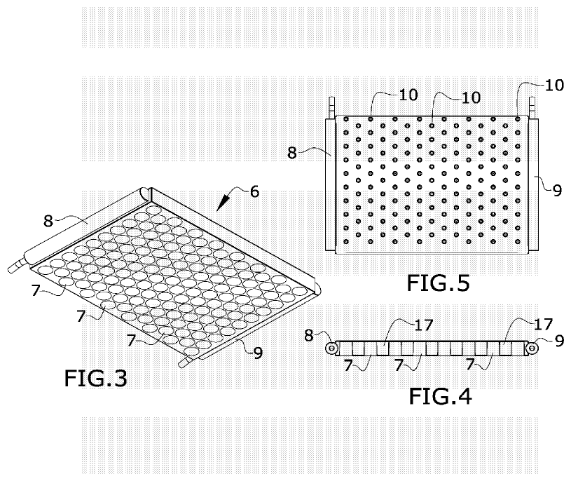

FIG. 3 shows the forming casing (6) of the ice cube-forming tray (2).

The forming casing (6) comprises:
a series of forming cavities (7) arranged in rows that are each staggered with respect to the next.
a first pumping tube (8) for the antifreeze fluid arranged attached to one side of the forming casing (6) and in connection with the inside space (17) defined between the forming cavities (7) and through which the antifreeze fluid flows in direct contact with the forming cavities.
a second return tube (9) for the antifreeze fluid arranged attached to one side of the forming casing (6) and in connection with the inside space (17) defined between the forming cavities (7).

FIG. 4 shows how the pumping (8) and return tubes (9) are attached to the sides of the forming casing (6) and in connection with the free space defined between the forming cavities (7).

FIG. 5 shows a top view of the forming casing (6) wherein a series of holes (10) can be seen, which are holes in connection with the forming cavities (7), with one hole per forming cavity (7), to allow for the inlet of air and for the ice cube to, once formed, be able to become detached.

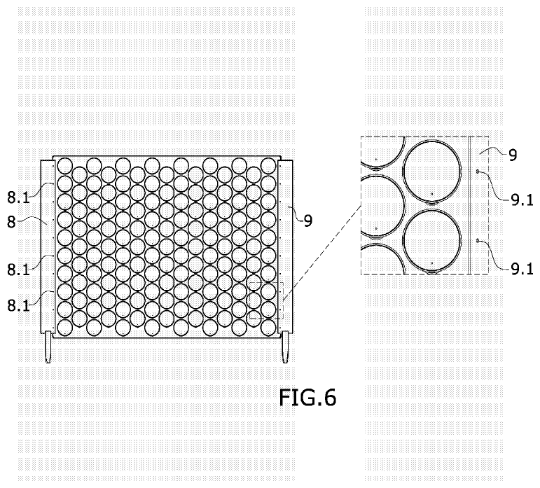

FIG. 6 shows how the connection of the pumping (8) and return tubes (9) is carried out, each of them having holes (8.1) and (9.1), through which the antifreeze liquid is pumped and through which the antifreeze liquid returns, respectively, after inundating the inside space (17) defined between the forming cavities.

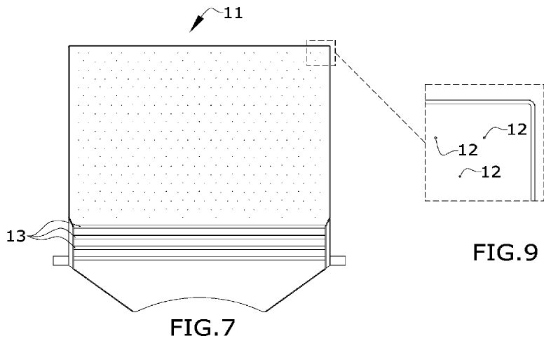

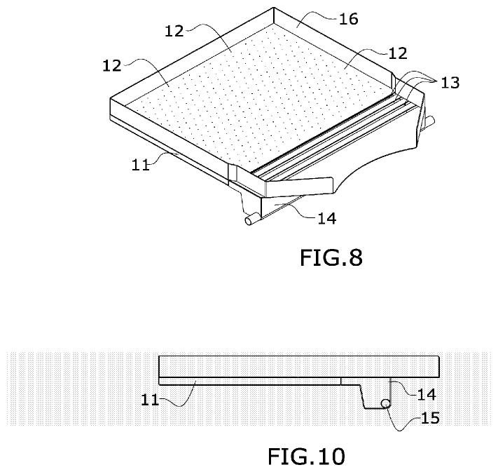

FIGS. 7 to 10 show the constructive features of the spraying and collection tray (11) which, as can be seen, comprises:
a bottom or base provided with a series of spraying holes (12) for spraying water at a very low temperature,
side walls (16) surrounding the perimeter of the bottom or base except for one side.
collection grates (13) for collecting the sprayed and non-frozen excess water which are arranged on the free side of the side wall (16).
a collection tank (14) for the sprayed and non-frozen water which has tubes (16) for the evacuation thereof.

FIG. 9 shows a possible embodiment in the geometric arrangement of the spraying holes (12) in relation to the forming cavities (7), in which, in the embodiment shown, three holes (12) are arranged per forming cavity (7), preferably in an arrangement forming an equilateral triangle.

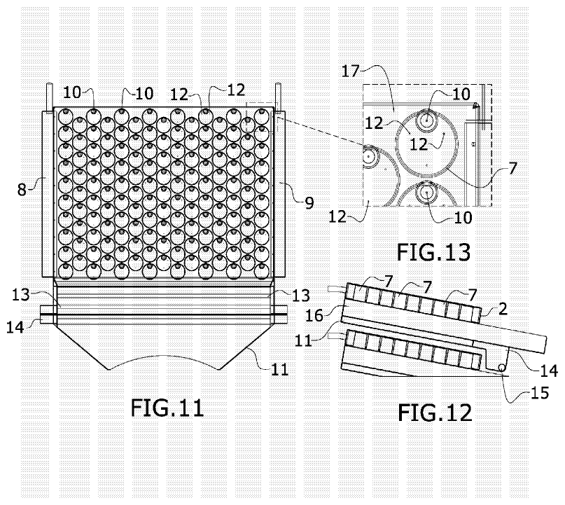

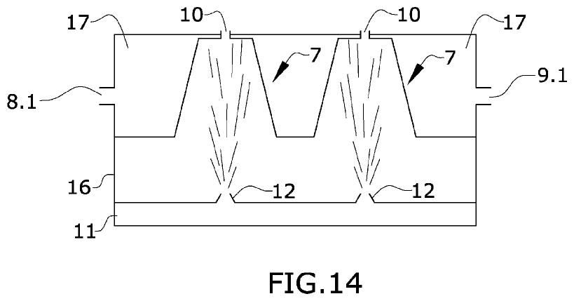

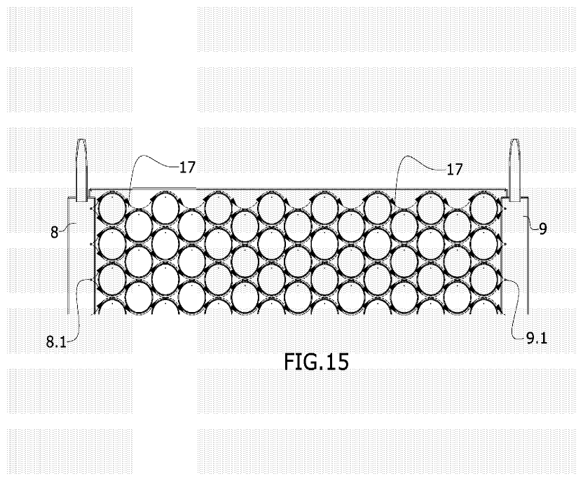

FIGS. 11 to 13 show the relationship of the position of the air inlet holes (10) and the spraying holes (12), showing that while the spraying holes (12) are centered with respect to the forming cavities, the air inlet hole (10) is arranged in the upper portion of the forming cavity (7), since the inclination of the tray in this manner ensures the inlet of air at the highest portion of the forming cavity (7), preventing a possible vacuum which would prevent the ice cube from falling once it is formed.

Lastly, FIG. 12 schematically shows the relative positioning of the elements described above.

FIG. 13 shows that, due to the staggered arrangement of the forming cavities (7), the antifreeze fluid is forced to run in an undulating manner between the cavities, achieving maximum contact with the forming cavities, which results in greater efficiency in the transmission of both cold and heat and, consequently, a greater reduction in energy consumption, as well as in the of antifreeze fluid load and production time.

Having thus adequately described the nature of the present invention, as well as how to put it into practice, it must be noted that, within its essential nature, the invention may be carried out according to other embodiments differing in detail from that set out by way of example, which the protection sought would equally cover, provided that the fundamental principle thereof is not altered, changed or modified.

1. A machine for producing ice cubes, comprising at least one column wherein a series of forming trays is arranged vertically aligned with a slight inclination, wherein the ice cubes produced are collected by means of spiral collection and are placed on a collecting belt,
wherein
the machine has at least two tanks of antifreeze liquid (one cold and one hot) to which the forming trays are connected,
each ice cube-forming tray comprises a forming casing under which a water spraying and collection tray are arranged for the excess water sprayed, as well as the cubes produced,
wherein the forming casing comprises:
a series of forming cavities arranged in rows that are each staggered with respect to the next,
a first pumping tube for the antifreeze fluid arranged attached to one side of the forming casing and in connection with the inside space defined between the forming cavities and through which the antifreeze fluid flows in direct contact with the forming cavities, and
a second antifreeze fluid return tube arranged attached to the opposite side of the forming casing to which the first pumping tube is attached, and said second return tube being connected to the inside space defined between the forming cavities.

2. The machine for producing ice cubes according to claim 1, wherein the spraying and collection tray comprises:
a bottom or base provided with a series of spraying holes for spraying water at a very low temperature,
side walls surrounding the perimeter of the bottom or base except for one side,
collection grates for collecting the sprayed and non-frozen excess water which are arranged on the free side of the side wall, and
a collection tank for the sprayed and non-frozen water which has tubes for the evacuation thereof.

3. The machine for producing ice cubes according to claim, wherein the forming casing comprises a series of holes, which are holes in connection with the forming cavities.

4. The machine for producing ice cubes according to claim 3, wherein the air inlet holes are positioned in the upper portion of each forming cavity.

5. The machine for producing ice cubes according to claim 1 wherein the connection of the pumping and return tubes to the inside space defined between the forming cavities is done through holes and, through which the antifreeze liquid is pumped and through which the antifreeze liquid returns, respectively, after inundating the inside space defined between the forming cavities.

6. The machine for producing ice cubes according to claim 1, wherein, in relation to the forming cavities, there are three spraying holes per forming cavity.

7. The machine for producing ice cubes according to claim 6, wherein the three spraying holes form an equilateral triangle centrally positioned with respect to the forming cavity.
